(19) United States
(12) Patent Application Publication
(10) Pub. No.: US 2002/0010555 A1
(43) Pub. Date: Jan. 24, 2002

(54) Ionization polarity prediction of compounds for efficient mass spectrometry

(75) Inventors: James Francis Blake, Mystic, CT (US); Adam Hale Brockman, North Stonington, CT (US); David Martin Potter, Ledyard, CT (US)

Correspondence Address: PFIZER INC, 150 EAST 42ND STREET, 5TH FLOOR - STOP 49, NEW YORK, NY, 10017-5612, US

(73) Assignee: Pfizer Inc.

(21) Appl. No.: 09/898,290

(22) Filed: Jul. 3, 2001

Related U.S. Application Data
(60) Provisional application No. 60/219,769, filed on Jul. 20, 2000.

(51) Int. Cl. G06F 19/00

(52) U.S. Cl. 702/30

(57) ABSTRACT

A method for segregating compounds by ionization polarity for use in polarity sensitive analysis thereof comprising the steps of:

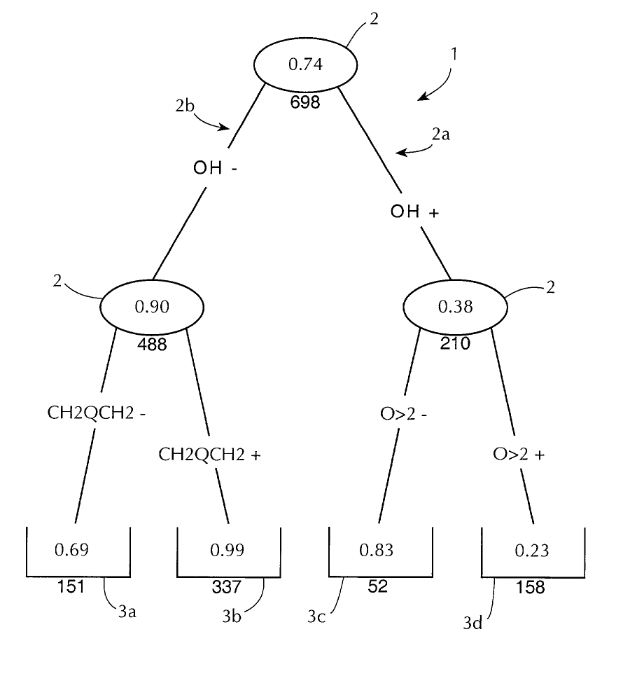

a) selecting a data base of a statistically significant group of compounds and determining the polarization, positive or negative, at which each of said compounds is ionized;

b) structurally analyzing the individual compounds to determine structural characteristics common to a majority of compounds which ionize at positive polarity and to determine structural characteristics common to a majority of compounds which ionize at negative polarity, as polarization determinants;

c) sequentially arranging the polarization determinants in classification trees according to percentage determination of one of said negative or positive polarization;

d) applying the polarization determinants in one of said classification trees in classifying a new compound for a predicted polarization of positive or negative at which said compound is ionized;

e) segregating compounds classified as ionizing at positive polarity and compounds classified as ionizing at negative polarity; and

f) separately analyzing the segregated compounds with the respective predicted polarities with an analysis instrument operable in different modes depending on ionization polarity.

### FIELD OF THE INVENTION

This invention relates to methods for increasing the efficiency of mass spectrometric analysis and particularly for use in drug compound screening procedures. This invention particularly relates to methods for pre-screening of candidate drug compounds, which are to be analyzed by mass spectroscopy for drug-drug interactions. It also particularly relates to a means for increasing the efficiency, speed, flexibility of use and throughput in which analytical results can be obtained on large numbers of compounds from said mass spectroscopy.

### BACKGROUND OF THE INVENTION

Since the number of molecules synthesized by pharmaceutical companies has dramatically increased with the utilization of combinatorial chemistry, there is now a shift in emphasis towards earlier implementation of higher throughput in vitro studies such as for metabolism or lead optimization. Thus, for example, the prediction of drug-drug interactions of new chemical entities using in vitro methods, such as human liver microsomes (HLMs), hepatocytes or individual expressed CYPs has escalated both in importance and scale of use, as one way to reliably avoid potential interactions in vivo. Analysis devices such as mass spectrometers are utilized in providing relevant screening data of such interactions as well as other beneficial or detrimental characteristics of candidate drug compounds.

In a mass spectrometer a compound sample flows through a fused silica capillary to a charged stainless steel needle held at high (3000-5000) voltage. This potential causes the formation of a liquid spray known as electrospray, wherein ions (both negative and positive) of the analyte are formed where they are then entrained into the mass analyzer sections of the instrument for the analysis. For consistency and validation of results, numerous sample feeds are effected. The numerous samples are loaded and injected in a cycle with the time of the cycle being the time between starting a series of samples (or an injection into the HPLC system) and the subsequent set of samples. At present, this cycle time is on the order of about one minute.

It is highly desirable to maximize the efficiency in utilizing the analysis devices such as mass spectrometers to provide screening information about the candidate drug compounds and particularly with respect to the manner in which samples are introduced to the mass spectrometer for analysis.

### SUMMARY OF THE INVENTION

It is accordingly an object of the present invention to provide a predictive and screening method for enhancing the efficiency and increasing the analysis throughput of an analysis device, such as a mass spectrometer, to increase the number of compounds which can be screened in a given period of time.

It is a further object of the present invention to provide a pre-selection method, which permits segregation of compounds having a common testing regimen, whereby they can be efficiently grouped for unified testing.

Generally the present invention comprises a method for presorting compounds by polarity in order to segregate compounds, such as by plating them into separate racks, to avoid problems of polarity matching in mass spectrometric quantitation.

The method of the present invention comprises the steps of:

a) selecting a data base of a statistically significant group of compounds and determining the polarization, positive or negative, at which each of said compounds is ionized;

b) structurally analyzing the individual compounds to determine structural characteristics common to a majority of compounds which ionize at positive polarity and to determine structural characteristics common to a majority of compounds which ionize at negative polarity, as polarization determinants;

c) sequentially arranging the polarization determinants in classification trees according to percentage determination of one of said negative or positive polarization;

d) applying the polarization determinants in one of said classification trees in classifying a new compound for a predicted polarization of positive or negative at which said compound is ionized;

e) segregating compounds classified as ionizing at positive polarity and compounds classified as ionizing at negative polarity; and

f) separately analyzing the segregated compounds with the respective predicted polarities with an analysis instrument operable in different modes depending on ionization polarity.

In accordance with the method of the present invention a series of identifiers are applied to compounds which identifiers are generally predictive of polarity along a decisional tree of parameters.

For example, it has been experimentally determined that a first identifier predictor is the presence of an hydroxyl (OH) group, with a majority of compounds having an OH group being ionized at positive polarity, whereas a clear minority are less likely to be polarized at a positive polarity.

A second determined identifier predictor is the number of oxygen atoms. Thus, compounds having more than two oxygen atoms are less likely to be ionized at a positive polarity whereas compounds with less than two oxygens are more likely to be ionized at a positive polarity.

In addition to simple predictive elements there is a discrimination possible by evaluating interactions. Thus, as determined, the number of oxygen atoms is a good discriminator for compounds which also have an OH group present but for compounds without an OH group present, a different discriminator feature is better, i.e., a CH₂QCH₂ moiety where Q represents an atom other than C or H.

It has been found that the tree-based discrimination as described is conservatively accurate in discrimination for about 87-89% of compounds tested. Accuracy is considerably higher since the percentages also reflect compounds, which will ionize at both polarities.

Once the predicted ionization polarity has been determined, compounds slated for testing are pre-sorted by polarity with the compounds being slated into separate racks to avoid the problem of polarity matching in mass spectrometric quantitation. This is particularly useful in multispray applications where a given set of 2 or 4 analytes must all ionize at the same polarity.

While the present invention has particular utility with respect to mass spectrometers, utility is similarly applicable to other instruments such as with regard to mobile phase pH, nebulization gas and other variables.

The above and other objects, features and advantages of the present invention will become more evident from the following discussion and drawings in which:

### SHORT DESCRIPTION OF THE DRAWING

The sole FIGURE is an example of a polarity classification tree with discrimination parameter branches and percentage of positive and negative polarities.

### DETAILED DESCRIPTION OF THE INVENTION AND DRAWING

With reference to the classification tree 1 in the figure, the number inside each node 2 of the tree indicates the fraction of the compounds with the indicated discrimination structure ionized at positive polarity, with “+” indicating present and “−” indicating absence.

As shown in the figure, starting at the top of the tree, there are 698 starting compounds which were analyzed for polarity during ionization, 74% of which were ionized at a positive polarity. The compounds are separated into two groups 2a and 2b, depending on whether an OH group is present (+) or absent (−). The 210 compounds with an OH group present are less likely to be ionized at positive polarity (38%), while the 488 compounds without an OH group drop down the tree to the left and are much more likely to be ionized at positive polarity (90%) The two groups are then further segregated based on the best discriminating factor for the particular group. The 210 compounds with an OH group present are divided based on whether there are more than two oxygen atoms present. Compounds with more than two oxygen atoms are less likely to be ionized at positive polarity (23%). In contrast, compounds with less than two oxygen atoms present are more likely to be ionized at positive polarity. Every compound in all of the groups ends up in one of the four bottom leaves 3a-d of the tree with the percentages in the respective leaves serving as predictions regarding how likely a compound with the particular structural set of discriminator structural elements will be ionized at positive polarity.

Because of the branched structure of the classification tree interactions between the effects of structural elements can be captured. Thus, the tree suggests that the number of oxygen atoms is a good discriminator for compounds but only if an OH group is present, otherwise as seen in the figure and the branches going down to the left, the presence or absence of CH₂QCH₂ groups, where Q is neither C or H, is a better discriminator of polarity (presence translates into 99% positive polarity).

In order to assess the potential performance of the method of the present invention, classification trees were built on 348 of the 698 compounds described above, and their predictive ability was evaluated with the remaining 350 compounds. Results based on this small sample indicates that the tree based method can accurately classify 87-89% of the compounds with respect to polarity for ionization. These data are however underestimates since the data used to generate the tree models were based on optimal ionization polarity and often a given compound will ionize at both polarities, especially where the prediction values lie near a selection threshold.

As described above, once the compounds are segregated based on predicted polarity then can be physically separately handled for highly efficient mass spectrometric quantitation especially where a given set of 2 or 4 analytes must all ionize at the same polarity.

It is understood that the above description and examples are merely illustrative of the present invention and that changes in method steps and parameters and the like may be made without departing from the scope of the present invention as defined in the following claims

What is claimed is:

1. A method for segregating compounds by ionization polarity for use in polarity sensitive analysis thereof, said method comprising the steps of:
a) selecting a data base of a statistically significant group of compounds and determining the polarization, positive or negative, at which each of said compounds is ionized;
b) structurally analyzing the individual compounds to determine structural characteristics common to a majority of compounds which ionize at positive polarity and to determine structural characteristics common to a majority of compounds which ionize at negative polarity, as polarization determinants;
c) sequentially arranging the polarization determinants in classification trees according to percentage determination of one of said negative or positive polarization;
d) applying the polarization determinants in one of said classification trees in classifying a new compound for a predicted polarization of positive or negative at which said compound is ionized;
e) segregating compounds classified as ionizing at positive polarity and compounds classified as ionizing at negative polarity; and
f) separately analyzing the segregated compounds with the respective predicted polarities with an analysis instrument operable in different modes depending on ionization polarity.

2. The method of claim 1, wherein said analysis instrument is a mass spectrometer.

3. The method of claim 2, wherein a polarization determinant is the presence of an OH group.

4. The method of claim 2, wherein a polarization determinant is one of the presence of more than two oxygen atoms and the presence of less than two oxygen atoms.

5. The method of claim 4, wherein the presence of more than two oxygen atoms or the presence of less than two oxygen atoms is a determinant, if an OH group is present.

6. The method of claim 5, wherein, in the absence of an OH group, the presence or absence of CH₂QCH₂ groups, where Q is neither C or H, is a discriminator of polarity.
